(19) United States
(12) Patent Application Publication
(10) Pub. No.: US 2012/0001964 A1
(43) Pub. Date: Jan. 5, 2012

(54) LIQUID CRYSTAL DISPLAY APPARATUS

(75) Inventors: Takeshi Masuda, Osaka-shi (JP); Kohji Fujiwara, Osaka-shi (JP); Hiroshi Il, Osaka-shi (JP); Tomohiko Yamamoto, Osaka-shi (JP)

(73) Assignee: Sharp Kabushiki Kaisha, Osaka-shi (JP)

(21) Appl. No.: 13/256,574

(22) PCT Filed: Nov. 13, 2009
(86) PCT No.: PCT/JP2009/069377

§ 371 Date: Sep. 14, 2011

(30) Foreign Application Priority Data
Mar. 26, 2009 (JP) 2009-075440

(51) Int. Cl. G09G 3/36; G09G 5/10

(52) U.S. Cl. 345/690; 345/88; 345/102

(57) ABSTRACT

In the present liquid crystal display device (1), LEDs included in a backlight (20) display a solid-blue display image in an LED lighting pattern suitable for a solid-blue display, which is stored in a lighting pattern storage portion (30) and selected by a lighting pattern selection portion (33) in accordance with a determination result by an image determination portion (32), and also display any other images, including a solid-white display image, in an LED lighting pattern suitable for a solid-white display, and therefore it is possible to reduce or eliminate display unevenness in the case where a solid-white display image is displayed, and also to reduce or eliminate display unevenness of a solid-blue display image, which is particularly noticeable.

### TECHNICAL FIELD

The present invention relates to liquid crystal display devices, particularly to a liquid crystal display device provided with a liquid crystal panel and a backlight including light sources for two or more colors.

### BACKGROUND ART

In liquid crystal display devices, a voltage is applied to control switches arranged in a matrix with a liquid crystal sealed between two transparent electrodes, thereby changing orientations of liquid crystal molecules, so that light transmittance is changed to optically display an image. The liquid crystal does not emit light by itself, and therefore it is necessary to provide the liquid crystal display device with a backlight or suchlike.

While various types of backlights are available, for example, large-sized liquid crystal televisions mainly use direct backlights. Direct backlights are configured by a plurality of light sources arranged on a plane and a diffuser panel provided between a liquid crystal panel and the light sources so as to keep them at a constant distance. Also, a plurality of LEDs (Light Emitting Diodes) are used to configure a direct backlight to perform, for example, local dimming drive, in which the luminance of the LEDs is controlled for each area in accordance with grayscale values of an image, or area-active drive, in which the luminance of the LEDs of each color is controlled for each area in accordance with color display data.

In general, LED backlights for various uses as above are configured using LED units which include red, green, and blue LEDs (see, for example, Japanese Laid-Open Patent Publication No. 10-39301). Alternatively, they may be configured using LED units which only include white LEDs or LED units which include white LEDs along with LEDs for the aforementioned three colors. Also, LED backlights are generally configured by a plurality of LED units arranged in a matrix on backlight boards. Alternatively, LED backlights may be configured using backlight boards on which a plurality of LED units are arranged in arrays.

When a number of LEDs for emitting various colors are arranged in a plane as above, color unevenness might occur due to variations during production or suchlike. For example, there is a conventional LED display device provided with buffers for storing luminance values being set for each type of light-emitting diode, as features for reducing such color unevenness, and the luminance can be suitably changed for each color by changing the set values of the buffers (see, for example, Japanese Laid-Open Patent Publication No. 6-195036). Furthermore, Japanese Laid-Open Patent Publication No. 6-195036 describes a configuration of a display panel including a plurality of display units, in which the buffer is provided for each display unit. With this configuration, it is possible to reduce display unevenness due to differences in chromaticity between the display units.

### CITATION LIST

### Patent Document

[Patent Document 1] Japanese Laid-Open Patent Publication No. 10-39301
[Patent Document 2] Japanese Laid-Open Patent Publication No. 6-195036

### SUMMARY OF THE INVENTION

### Problems to be Solved by the Invention

However, while the conventional configuration described in Japanese Laid-Open Patent Publication No. 6-195036 can reduce display unevenness with a certain color mixture, e.g., a solid-white display (the entire screen or an area of the screen displays solely white), but cannot additionally reduce display unevenness with some other color mixture, e.g., a solid-blue display (the entire screen or an area of the screen displays solely blue).

Specifically, there are variations in characteristics among LEDs that emit the same color (concretely, their relationships between emission luminance and emission wavelength), and therefore, for example, even in the case where the luminance of the LEDs is appropriately adjusted for each color to reduce display unevenness in a solid-white display in order to provide a normal display, when a solid-color display is provided with another color (the entire screen or an area of the screen displays solely the same color), display unevenness noticeably appears (or is evident), which is a problem.

Therefore, an objective of the present invention is to provide a liquid crystal display device capable of reducing display unevenness even in the case of providing a solid-color display different from a normal display.

### Solution to the Problems

A first aspect of the present invention is directed to a liquid crystal display device having a function of controlling backlight luminance, comprising:

a liquid crystal panel for displaying an image based on external video data;

a backlight including a plurality of light sources for each of two or more primary colors, independently controllable for luminance;

an image determination portion for determining whether the image in its entirety or in part is a solid-color display image of at least almost only a single predetermined color;

a storage portion having solid-color display data and normal display data stored therein, the solid-color display data determining the luminance of the light sources and being preset such that the solid-color display image is displayed on the liquid crystal panel without unevenness, the normal display data determining the luminance of the light sources and being preset in order to provide a display image different from the solid-color image; and

a lighting control portion for controlling the light sources based on the solid-color display data stored in the storage portion when the determination by the image determination portion indicates the solid-color display image and based on the normal display data stored in the storage portion when otherwise.

In a second aspect of the present invention, based on the first aspect of the invention, when the determination indicates the solid-color display image, the image determination portion makes another determination as to whether the image in its entirety or in part is one of a plurality of solid-color display images that has a different one of the two or more primary colors as the single color, the storage portion has stored therein a plurality of pieces of solid-color display data corresponding to the solid-color display images, the solid-color display data determining the luminance of the light sources and being preset such that their corresponding solid-color display images are displayed on the liquid crystal panel without unevenness, and when the determination by the image determination portion indicates the solid-color display image, the lighting control portion controls the light sources based on one piece of the solid-color display data stored in the storage portion that corresponds to the determination result by the image determination portion.

In a third aspect of the present invention, based on the first aspect of the invention, the solid-color display data stored in the storage portion is preset such that a solid-color display image of one color other than white as the single color is provided without unevenness, and the normal display data stored in the storage portion that determines the luminance of the light sources is preset such that a display image of at least almost only white is provided without unevenness.

In a fourth aspect of the present invention, based on the first aspect of the invention, at least one of the solid-color display images has blue as the single color, the blue being one of the two or more primary colors including red, blue, and green.

In a fifth aspect of the present invention, based on the first aspect of the invention, the image determination portion makes the determination based on color-by-color average signal levels included in the video signal.

In a sixth aspect of the present invention, based on the first aspect of the invention, the backlight includes light-emitting diodes as the light sources.

In a seventh aspect of the present invention, based on the first aspect of the invention, the backlight is of a direct type in which the light sources are disposed along a plane opposite to a display surface of the liquid crystal panel.

An eighth aspect of the present invention is directed to a method for controlling a liquid crystal display device with a liquid crystal panel for displaying an image based on external video data and a backlight including a plurality of light sources for each of two or more primary colors, independently controllable for luminance, the method comprising:

an image determination step of determining whether the image in its entirety or in part is a solid-color display image of at least almost only a single predetermined color;

a storage step of storing solid-color display data and normal display data, the solid-color display data determining the luminance of the light sources and being preset such that the solid-color display image is displayed on the liquid crystal panel without unevenness, the normal display data determining the luminance of the light sources and being preset in order to provide a display image different from the solid-color image; and

a lighting control step of controlling the light sources based on the solid-color display data stored in the storage step when the determination in the image determination step indicates the solid-color display image and based on the normal display data stored in the storage step when otherwise.

### Effect of the Invention

According to the first aspect of the present invention, the light sources are controlled based on the solid-color display data stored in the storage portion when the determination by the image determination portion indicates the solid-color display image or based on the normal display data stored in the storage portion when otherwise, and therefore it is possible to reduce or eliminate display unevenness of the solid-color display image, which is noticeable when such control is based on the normal display data.

According to the second aspect of the present invention, the light sources are controlled based on one piece of the solid-color display data stored in the storage portion that corresponds to the determination result by the image determination portion, and therefore it is possible to reduce or eliminate display unevenness of solid-color display images of any colors, which is noticeable when such control is based on other pieces of the data.

According to the third aspect of the present invention, the lighting control portion uses the stored normal display data being preset such that a display image of at least almost only white is provided without unevenness, and by using such normal display data, it becomes possible to reduce or eliminate display unevenness of a solely white display image, provide a more even image in the case of a normal display, and reduce or eliminate display unevenness of any solid-color display images other than white.

According to the fourth aspect of the present invention, at least one of the solid-color display images is a solid-blue display image, and therefore if the blue emission intensity of the backlight is adjusted, for example, so as to provide a white display without unevenness as in the conventional art, adjustments are made focusing attention on the Z value of the stimulus values for blue, which most affects the tristimulus values for white, making it possible to reduce or eliminate display unevenness of solid-blue display images, which are particularly prone to unevenness.

According to the fifth aspect of the present invention, the determination is made based on color-by-color average signal levels included in the video signal, and therefore the determination can be made readily and rapidly.

According to the sixth aspect of the present invention, by using light-emitting diodes, which are superior in terms of color reproduction, luminous capability, size, life, etc., it becomes possible to readily configure a backlight including a plurality of light sources independently controllable for luminance, and also to reduce or eliminate display unevenness of solid-color display images, which readily occurs due to variations in characteristics among the light-emitting diodes used.

According to the seventh aspect of the present invention, the direct backlight makes it possible to reduce or eliminate noticeable display unevenness of solid-color display images.

According to the eighth aspect of the present invention, the control method as an aspect of the invention can achieve the same effect as that achieved by the first aspect of the invention.

### BRIEF DESCRIPTION OF THE DRAWINGS

FIG. 1 is a block diagram illustrating the configuration of a liquid crystal display device according to an embodiment of the present invention.

FIG. 2 is a block diagram illustrating the configuration of a liquid crystal display device driven by an area-active mode in a variant of the embodiment.

FIG. 3 provides cross-sectional views of a liquid crystal panel and a backlight of the liquid crystal display device in the embodiment.

FIG. 4 is a graph showing an emission spectrum of a light-emitting block which includes three LEDs for emitting three colors in the embodiment.

FIG. 5 is a graph showing color-matching functions represented by an XYZ color system.

FIG. 6 is a graph showing the relationship between the emission intensity distribution and the color-matching functions for a blue LED with an average emission wavelength in the embodiment.

FIG. 7 is a graph showing the relationship between the emission intensity distribution and the color-matching functions for a blue LED with an emission wavelength higher than the average in the embodiment.

### MODE FOR CARRYING OUT THE INVENTION

Hereinafter, an embodiment of the present invention will be described with reference to the drawings. Note that the present invention should not be construed to be limited to the embodiment to be described below, various modifications can be made without departing from the spirit of the invention, and variants and improvements based on the basic concept of the invention are also included in the scope of the invention.

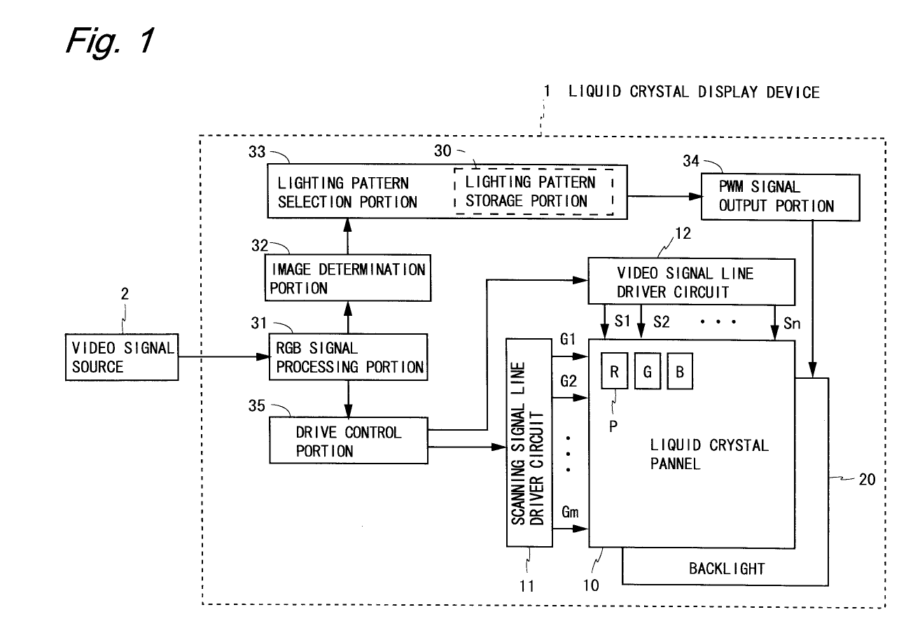

FIG. 1 is a block diagram illustrating the configuration of a liquid crystal display device according to the embodiment of the present invention. The liquid crystal display device 1 shown in FIG. 1 is provided with a liquid crystal panel 10, a scanning signal line driver circuit 11, a video signal line driver circuit 12, a backlight 20, an RGB signal processing portion 31, an image determination portion 32, a lighting pattern selection portion 33, a PWM signal output portion 34, and a drive control portion 35. In addition, the lighting pattern selection portion 33 includes a lighting pattern storage portion 30. In the following, m is assumed to be an integer of 2 or more, and n is assumed to be a multiple of 3.

The liquid crystal panel 10 includes m scanning signal lines G₁ to Gₘ, n video signal lines S₁ to Sₙ, and (m×n) pixel circuits P. The scanning signal lines G₁ to Gₘ are arranged parallel to one another, and the video signal lines S₁ to Sₙ are arranged parallel to one another so as to be perpendicular to the scanning signal lines G₁ to Gₘ. The pixel circuits P are provided in the vicinity of intersections of the scanning signal lines G₁ to Gₘ and the video signal lines S₁ to Sₙ. The pixel circuits P are each provided with a color filter for red, green, or blue. The pixel circuit P provided with a color filter for red, green, or blue, functions as a red, green, or blue display element. These three types of pixel circuits P are arranged side by side in the extending direction (in FIG. 1, horizontal direction) of the scanning signal lines G₁ to Gₘ, and three of them form one pixel. In this manner, the liquid crystal panel 10 has color filters for three colors.

The scanning signal line driver circuit 11 and the video signal line driver circuit 12 are driver circuits for the liquid crystal panel 10. The scanning signal line driver circuit 11 drives the scanning signal lines G₁ to Gₘ, and the video signal line driver circuit 12 drives the video signal lines S₁ to Sₙ. More specifically, the scanning signal line driver circuit 11 selects one of the scanning signal lines G₁ to Gₘ in accordance with a timing control signal outputted by the drive control portion 35, and provides a selection voltage (e.g., a high-level voltage) to the selected scanning signal line and a non-selection voltage (e.g., a low-level voltage) to the other scanning signal lines. The video signal line driver circuit 12 provides a voltage, which corresponds to a video signal outputted by the drive control portion 35, to the video signal lines S₁ to Sₙ in accordance with a timing control signal outputted by the drive control portion 35. When driving the video signal lines S₁ to Sₙ, the video signal line driver circuit 12 may perform either dot-sequential drive or line-sequential drive.

The backlight 20 is provided at the backside of the liquid crystal panel 10, and irradiates the back of the liquid crystal panel 10 with light (backlight radiation). As light sources, the backlight 20 includes red, green, and blue LEDs, one or more for each color, independently controllable for luminance. To control the luminance of the LEDs, the PWM signal output portion 34 outputs a PWM (Pulse Width Modulation) signal. This will be described in detail later. Note that the color temperature of the LEDs is changed by operating current, and therefore to achieve precise color reproduction, it is necessary to control the LEDs through PWM control, and suppress a change in color of light emitted from the LEDs.

The lighting pattern storage portion 30 included in the lighting pattern selection portion 33 is configured by, for example, semiconductor memory, and having stored therein a plurality of patterns of PWM data required for the operation of the PWM signal output portion 34. The lighting pattern selection portion 33 selects one of the patterns stored in the lighting pattern storage portion 30, and provides it to the PWM signal output portion 34. These operations will also be described in detail later.

Provided outside the liquid crystal display device 1 is a video signal source 2 for outputting a composite video signal. The RGB signal processing portion 31 performs, for example, chroma processing and matrix transformation on the composite video signal outputted by the video signal source 2, and outputs an RGB separation signal. Note that when the RGB signal is directly provided from outside, the RGB signal processing portion 31 is omitted.

The image determination portion 32 determines whether or not an image to be displayed is a solid-blue display image (a solely blue image) based on the RGB separation signal outputted by the RGB signal processing portion 31, and provides the determination result to the lighting pattern selection portion 33. The reason and the method for making such a determination will be described in detail later.

Note that hereinafter, a display provided with a solely single color will be referred to as a solid-color display, and an image of a solid-color display will be referred to as a solid-color display image. In addition, the solid-color display depends on visual perception, and therefore can be provided using almost only a single color, i.e., it may include a different color to a certain degree.

In accordance with video data for use in driving the liquid crystal panel 10, which is obtained based on the RGB separation signal outputted by the RGB signal processing portion 31, the drive control portion 35 outputs a timing control signal to the scanning signal line driver circuit 11, along with a timing control signal and a video signal to the video signal line driver circuit 12. The scanning signal line driver circuit 11 and the video signal line driver circuit 12 drive the liquid crystal panel 10 based on the output signals from the drive control portion 35. As a result, the light transmittance of the pixel circuits P in the liquid crystal panel 10 is changed. On the other hand, the LEDs in the backlight 20 emit light with luminance according to the control of the PWM signal output portion 34. The liquid crystal panel 10 and the backlight 20 are driven in this manner, thereby displaying a desired image.

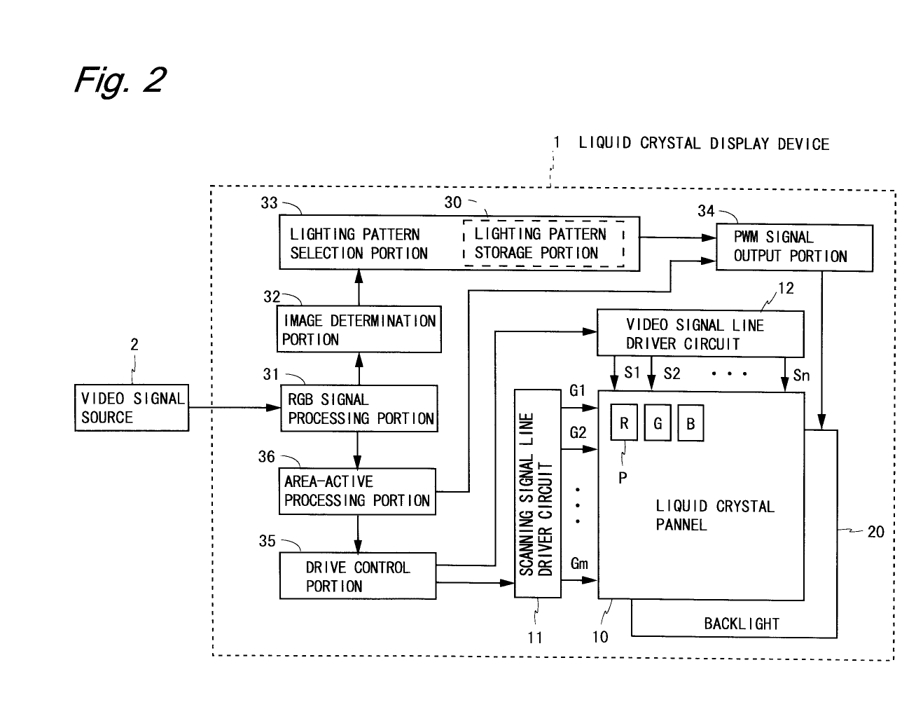

Note that in the present embodiment, the backlight 20 does not employ local dimming drive or area-active drive as a mode of drive, but any of these drive methods may be employed in variants of the present embodiment. For example, in the case where area-active drive is employed, the liquid crystal display device 1 further includes an area-active processing portion 36, as shown in FIG. 2, and the area-active processing portion 36 has PSF (Point Spread Function) data, etc., stored therein. Furthermore, the area-active processing portion 36 divides the RGB separation signal outputted by the RGB signal processing portion 31 into a plurality of areas, and obtains luminance values for light sources corresponding to each area and RGB backlight data for use in driving the backlight, based on the tone of the RGB separation signal in that area and the PSF data. RGB video data obtained by referencing the backlight data is outputted to the drive control portion 35, and the RGB backlight data to the PWM signal output portion. In accordance with video data for use in driving the liquid crystal panel 10, which is obtained based on the RGB video data outputted by the area-active processing portion 36, the drive control portion 35 outputs a timing control signal to the scanning signal line driver circuit 11, along with a timing control signal and a video signal to the video signal line driver circuit 12. The scanning signal line driver circuit 11 and the video signal line driver circuit 12 drive the liquid crystal panel 10 based on the output signals from the drive control portion 35. As a result, the light transmittance of the pixel circuits P on the liquid crystal panel 10 is changed. On the other hand, the LEDs in the backlight 20 emit light with luminance according to the control of the PWM signal output portion 34, which is obtained based on the RGB backlight data outputted by the area-active processing portion 36. The luminance of the pixels of the liquid crystal panel 10 is changed in accordance with the luminance of the LEDs and the light transmittance of the pixel circuits P. The liquid crystal panel 10 and the backlight 20 are driven in this manner, thereby displaying a desired image.

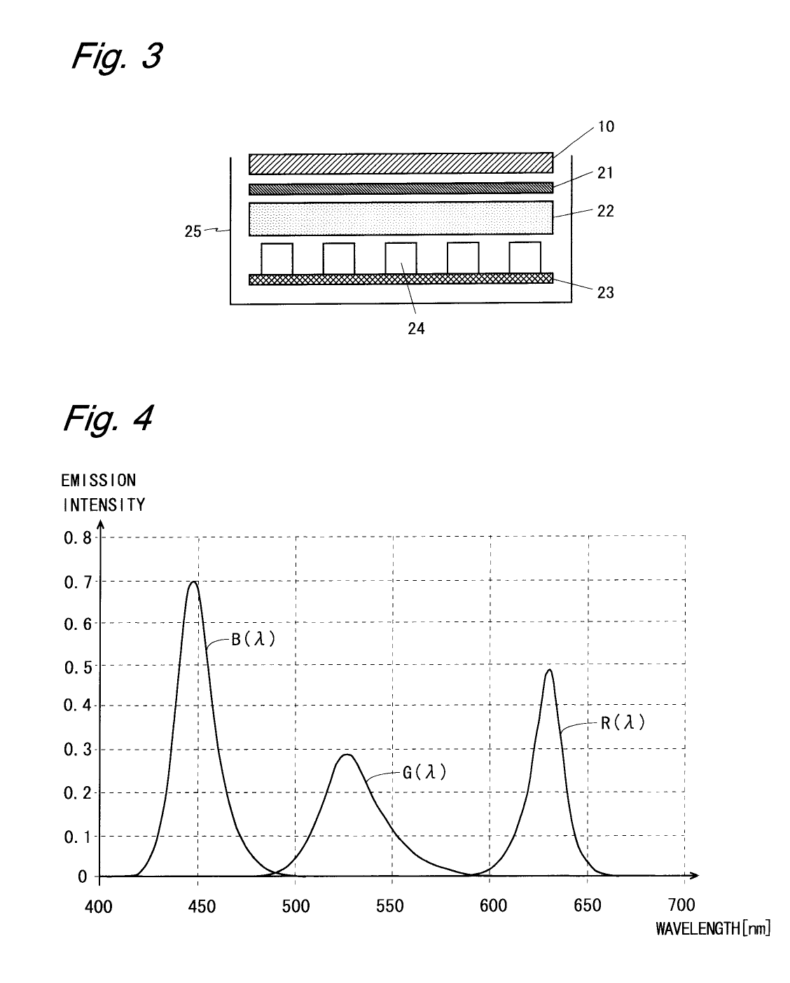

FIG. 3 provides cross-sectional views of the liquid crystal panel 10 and the backlight 20. As shown in FIG. 3, a backlight casing 25 is provided at the backside of the liquid crystal panel 10. Provided within the backlight casing 25 are an optical sheet group 21, a diffuser panel 22, and a plurality of backlight boards 23, each having a plurality of LEDs 24 mounted thereon. In this manner, the backlight 20 is configured using the optical sheet group 21, the diffuser panel 22, the backlight boards 23, the LEDs 24, and the backlight casing 25. Each backlight board 23 is provided with a plurality of backlight units, each including one or more light-emitting blocks of, for example, red, green, and blue LEDs. In addition, a plurality of such backlight boards 23 are arranged along a plane direction so as to be opposed to the liquid crystal panel 10. Accordingly, the backlight 20 functions as a planar light source for the liquid crystal panel 10.

Note that the present embodiment aims to reduce display unevenness due to variations in characteristics among the LEDs (more strictly, variations in the relationship between emission luminance and emission wavelength, which are caused by various factors such as individual differences between the LEDs and between related components) as will be described in detail later. Accordingly, two or more backlight units are required. However, when the number of backlight units is small for the size of the liquid crystal panel, the amount of backlight radiation might be insufficient or uneven luminance might occur in a displayed image. Therefore, for a liquid crystal panel of, for example, about 40 inches, a total of 500 or more backlight units are preferably arranged on, for example, sixteen backlight boards.

Next, the operation of LED lighting control by the image determination portion 32 and the lighting pattern selection portion 33 will be described with reference to FIGS. 4 through 7, along with a theoretical premise thereof. Note that the image determination portion 32 and the lighting pattern selection portion 33 collectively function as a lighting control portion because they perform LED lighting control based on data stored in the lighting pattern storage portion 30.

FIG. 4 is a graph showing an emission spectrum of a light-emitting block which includes three LEDs for emitting three colors. B (λ) shown in FIG. 4 represents an emission intensity of a blue LED corresponding to wavelength λ, G(λ) represents an emission intensity of a green LED corresponding to wavelength λ, and R (λ) represents an emission intensity of a red LED corresponding to wavelength λ.

As shown in FIG. 4, the light-emitting block emits light of three colors with predetermined emission intensities from the three LEDs, and therefore by suitably adjusting the LEDs for their emission intensities in each of a plurality of light-emitting blocks thus provided, uneven luminance in a solid-white display can be reduced or eliminated. However, such adjustments are required to be made in accordance with spectral sensitivity of the human eye, and specifically, the LEDs for the colors are required to be adjusted for their tristimulus values X, Y (luminance), and Z, such that the tristimulus values for white indicate predetermined chromaticity (white) values.

Here, the relationship between chromaticity (x,y) and tristimulus values X, Y, and Z can be expressed by the following equations (1) and (2).

x=X/(X+Y+Z) (1)

y=Y/(X+Y+Z) (2)

Accordingly, to obtain desired chromaticity (x,y) for white, tristimulus values X (W), Y (W), and Z (W) for white are suitably adjusted, as expressed by equations (1) and (2) above. In addition, the tristimulus values for white are equal to their respective sums of tristimulus values for red, green, and blue, and therefore where tristimulus values for red are X (R), Y (R), and Z (R), tristimulus values for green are X (G), Y(G), and Z (G), tristimulus values for blue are X(B), Y(B), and Z(B), and adjustment factors for emission intensities of the colors are r, g, and b, respectively, their relationships can be expressed by the following equation (3).

$$( \begin{matrix}X ( W ) \\ Y ( W ) \\ Z ( W )\end{matrix} ) = r ( \begin{matrix}X ( R ) \\ Y ( R ) \\ Z ( R )\end{matrix} ) + g ( \begin{matrix}X ( G ) \\ Y ( G ) \\ Z ( G )\end{matrix} ) + b ( \begin{matrix}X ( B ) \\ Y ( B ) \\ Z ( B )\end{matrix} ) \qquad ( 3 )$$

Here, to display preferable white, equation (3) above has the aforementioned values substituted with concrete numerical values and is expressed as, for example, the following equation (4).

$$( \begin{matrix}492 \\ 510 nt \\ 819\end{matrix} ) = 0.809 ( \begin{matrix}308 \\ 138 nt \\ 0.312\end{matrix} ) + 0.778 ( \begin{matrix}124 \\ 475 nt \\ 50.1\end{matrix} ) + 1.00 ( \begin{matrix}147 \\ 30.6 nt \\ 782\end{matrix} ) \qquad ( 4 )$$

Referring to equation (4) above, it can be appreciated that, of the tristimulus values for the colors, the Z value for blue, Z(B), most affects the tristimulus values for white. Specifically, the proportion of Z(B) in Z(W) is calculated to be about 95% by equation (4) above, and therefore the emission intensity of each blue LED is adjusted focusing attention on the Z value for blue, Z(B).

Accordingly, in the case where a solid-white display is provided, for example, when adjustments are made to obtain the same luminance across the entire display surface, the Z value for blue, Z(B), is also adjusted to be at the same level across the entire display surface. In addition, for example, when adjustments are made to obtain a predetermined luminance distribution across the entire display surface (typically, a luminance distribution in which the center of the display surface is the brightest and the brightness decreases toward the periphery), the Z value for blue, Z(B), is consequently adjusted to the same distribution state.

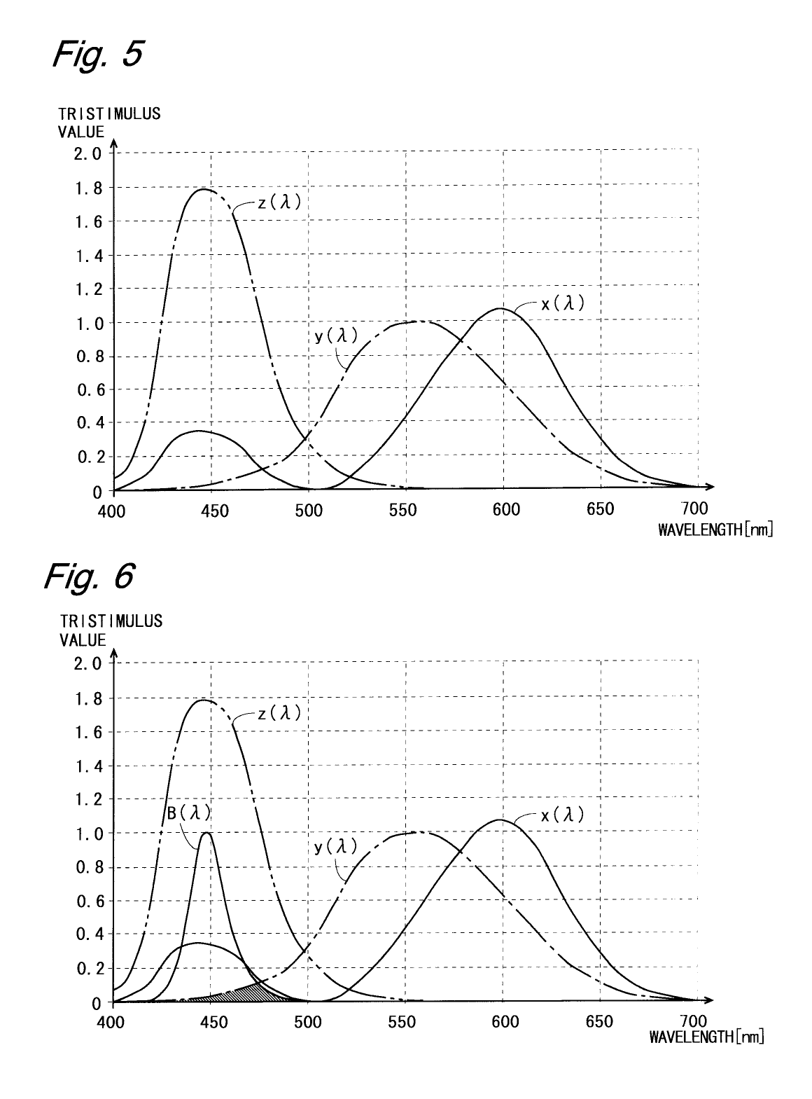

However, if the Z value for blue is adjusted in such a manner in accordance with the luminance distribution for white, the luminance distribution for blue is rendered nonuniform (rippled) when a solid-blue display is provided, resulting in noticeably uneven luminance. The reason for this is that the emission luminance of each blue LED suitably adjusted in the solid-white display significantly varies in accordance with the LED's emission wavelength, and concretely, the longer the emission wavelength, the higher the emission luminance. This will be described below with reference to FIGS. 5 to 7.

FIG. 5 is a graph showing color-matching functions represented by an XYZ color system. The color-matching functions shown in FIG. 5 are wavelength functions x(λ), y(λ), and z(λ) represented in the XYZ color system based on tristimulus values obtained through experimentation for monochromatic components (of all light of visible wavelengths) of equi-energy spectra in an RGB trichromatic system.

By using the color-matching functions, tristimulus values can be obtained for each color based on emission intensities B(λ), G(λ), and R(λ) of the light-emitting block including three LEDs for emitting three colors. For example, tristimulus values X(λ), Y(λ), and Z(λ) for blue can be obtained as in the following equations (5) to (7), respectively. Note that ∫ is the integral symbol.

X(B)=∫B(λ)·x(λ)dλ (5)

Y(B)=∫B(λ)·y(λ)dλ (6)

Z(B)=∫B(λ)·z(λ)dλ (7)

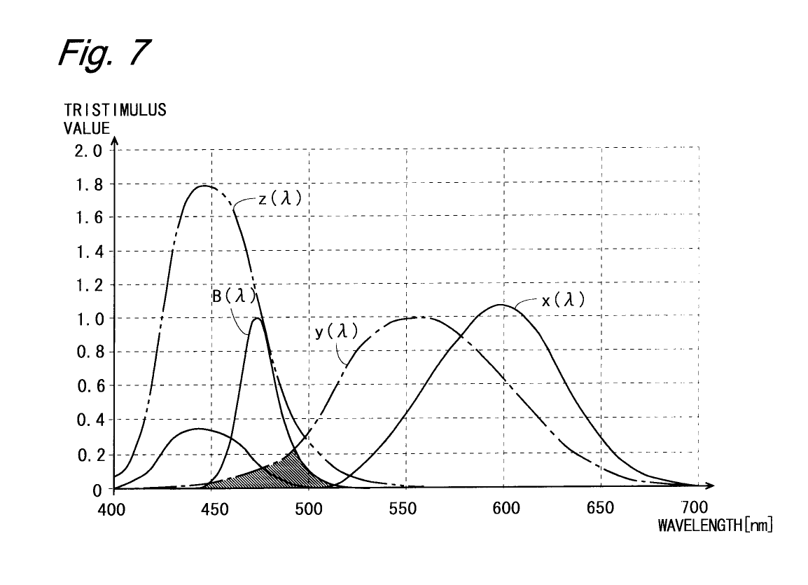

Here, the relationship between Z (B) and the emission wavelength of the blue LED will be described with reference to FIGS. 6 and 7. FIG. 6 is a graph showing the relationship between the emission intensity distribution and the color-matching functions for a blue LED with an average emission wavelength, and FIG. 7 is a graph showing the relationship between the emission intensity distribution and the color-matching functions for a blue LED with an emission wavelength higher than the average.

Hatched portions shown in FIGS. 6 and 7 represent the products of the emission intensity B(λ) of the blue LED and the color-matching function y(λ), and as can be appreciated with reference to equation (6) above, the hatched portions correspond to Y(B). Moreover, although not specifically shown in the figures, an overlap between the emission intensity B (λ) of the blue LED and the color-matching function z (λ) corresponds to Z(B), as can be appreciated with reference to equation (7) above.

In addition, as can be appreciated by comparing FIGS. 6 and 7 with respect to Z (B), Z (B) does not change if the emission wavelength of the blue LED slightly increases. On the other hand, it can be appreciated that Y (B), which corresponds to the hatched portions in the figures, sharply increases if the emission wavelength of the blue LED increases even slightly (if it shifts to the right in the figures). Accordingly, in the case where the Z value for blue is adjusted in accordance with luminance distribution for white, any adjustments in accordance with the emission wavelength of the blue LED are not made (not required to be made), and therefore, focusing attention on any blue LED with a longer emission wavelength than other blue LEDs because of variations during production, the emission luminance of such an LED is higher than the emission luminance of other blue LEDs. Inversely, some blue LEDs might have lower emission luminance than others. Consequently, when a solid-blue display is provided, uneven luminance becomes noticeable.

Therefore, the lighting pattern storage portion 30 has stored therein PWM data which allows an LED lighting pattern suitable for a solid-white display, e.g., PWM data which allows all LEDs to emit light with such an emission intensity as to satisfy equation (4) above, along with PWM data which allows an LED lighting pattern suitable for a solid-blue display.

Furthermore, based on an RGB separation signal outputted by the RGB signal processing portion 31, the image determination portion 32 determines whether or not an image to be displayed with on the signal is a solid-blue display image, and provides the determination result to the lighting pattern selection portion 33. Concretely, the image determination portion 32 extracts an average signal level (hereinafter referred to as an “ASL”) from the RGB separation signal for each color, and determines the image to be a solid-blue display image if the ASLs for red and green are both below their predetermined thresholds. By doing so, the determination can be made readily and rapidly.

The lighting pattern selection portion 33 acquires the determination result by the image determination portion 32, and provides the PWM signal output portion 34 with PWM data after acquiring it from the lighting pattern storage portion 30, the PWM data allowing an LED lighting pattern suitable for a solid-blue display when the determination indicates a solid-blue display image or a solid-white display when the determination does not indicate a solid-blue display image. The PWM data defines the current that is to flow to the LEDs with a PWM signal generated by the PWM signal output portion 34, and concretely, it may determine the pulse width of the PWM signal or the duty cycle thereof. However, the luminance of backlight is often changed (or is adjusted) in accordance with a user instruction or suchlike, and therefore in practice, the PWM data is provided to the PWM signal output portion 34 after being changed in accordance with the luminance designated by the user, rather being provided without any change. Accordingly, the PWM data may be an adjustment value by which to multiply the luminance designated by the user or an adjustment value to be added to such luminance.

Here, although the LED lighting pattern suitable for a solid-white display is used for any image which is not a solid-blue display image, it does not cause any practical issue because display unevenness is not noticeable (recognizable) in any normal image which is not a solid-color display image. Therefore, a lighting pattern suitable for a solid-blue display or another lighting pattern can be employed for any image which is not a solid-blue display image, but it is often the case that a normal image which is not a solid-color display is prone to be mixed with red, green, and blue, as in the case of a white solid-color display, and therefore it is preferable to use a lighting pattern suitable for a solid-white display. In addition, by making adjustments to render display unevenness unnoticeable in a solid-white display, display unevenness (even if it is not a practical issue) can be rendered unnoticeable in any normal image. In this regard, the LED lighting pattern suitable for a solid-blue display functions as a lighting pattern specifically designated for any solid-color display, whereas it can be said that the LED lighting pattern suitable for a solid-white display does not function as a specialized lighting pattern for a solid-color display.

As described above, when displaying a solid-blue display image, the LEDs included in the backlight 20 provide the display in an LED lighting pattern suitable for a solid-blue display, which is selected by the lighting pattern selection portion 33 in accordance with a determination result by the image determination portion 32, and when displaying any other images, including a solid-white display image, the displays are provided in an LED lighting pattern suitable for a solid-white display, making it possible for the present liquid crystal display device to reduce or eliminate display unevenness in the case where a solid-white display image is displayed, and also to reduce or eliminate display unevenness of a solid-blue display image, which is particularly noticeable for the reasons mentioned above.

While in the present embodiment, the PWM signal output portion 34 has been described as providing the PWM signal to all LEDs in the backlight 20 consisting of a plurality of backlight units, the PWM signal output portion 34 may be provided for each LED or for each one or more backlight units. In particular, in the case where a number of backlight units are included, it is preferable that, for example, the PWM signal output portion 34 be provided for each backlight board which includes one or more backlight units, in order to facilitate easy wiring. In this configuration, PWM data selected by the lighting pattern selection portion 33, or (LED emission) luminance data equivalent thereto, is provided to the PWM signal output portion on each board, for example, via a serial communication cable. In addition, it is conceivable that the lighting pattern selection portion 33 and the lighting pattern storage portion 30 are also provided for each backlight board, and a control signal corresponding to a determination result by the image determination portion 32 is provided to the lighting pattern selection portion on each board.

Also, in the present embodiment, while two lighting patterns are switched and used depending on whether or not to provide a solid-blue display image, the two lighting patterns may be switched depending on whether or not to provide a solid-color display image other than blue, or three or more lighting patterns may be switched and used for a plurality of solid-color display images of different colors. For example, the lighting pattern storage portion 30 may hold four pieces of PWM data corresponding to a total of four lighting patterns, including an LED lighting pattern suitable for a solid-red display and an LED lighting pattern suitable for a solid-green display, in addition to an LED lighting pattern suitable for a solid-white display and an LED lighting pattern suitable for a solid-blue display; based on an RGB separation signal outputted by the RGB signal processing portion 31, the image determination portion 32 may determine which solid-color display image should be displayed with the signal, and provide the determination result to the lighting pattern selection portion 33; the lighting pattern selection portion 33 may acquire corresponding PWM data from the lighting pattern storage portion 30. In this case, the LED lighting pattern suitable for a solid-white display is preferably used for any images other than solid-blue, red, and green display images, as described earlier. As a result, it is possible to reduce or eliminate display unevenness of solid-color display images of any other colors, which is likely to be noticeable when images are provided based on data corresponding to those colors (including white).

Note that, referring to equation (4) above, of the tristimulus values for colors, Z (B) is the tristimulus value that most affects the tristimulus values for white, as described earlier, and therefore using an LED lighting pattern suitable for a solid-blue display is very effective in reducing uneven luminance, but using an LED lighting pattern suitable for a solid-red or solid-green display also achieves a similar effect of reducing uneven luminance. Specifically, as for a solid-red display, from equation (4) above, the proportion of X (R) in X (W) is about 51%, and therefore when the X value for red is adjusted in accordance with luminance distribution for white, almost no adjustment is made in accordance with a red LED emission wavelength (i.e., there is no significant need for such an adjustment), resulting in noticeable uneven luminance when the solid-red display is provided as such, as in the case of blue. Therefore, using the LED lighting pattern for a solid-red display is also sufficiently effective in reducing uneven luminance. Furthermore, as for a solid-green display, from equation (4) above, the proportion of Y (G) in Y (W) is about 72%, but the proportion of X (G) in X (W) is about 20%, and therefore, while focusing additional attention on this, if the X value for green is adjusted in accordance with luminance distribution for white, adjustments are made in accordance with color LED emission wavelengths, considering the color-matching function x (λ), resulting in uneven luminance being noticeable to a certain extent when the solid-green display is provided as such. Therefore, using the LED lighting pattern for a solid-green display is also sufficiently effective in reducing uneven luminance.

Furthermore, while the present embodiment has been described with respect to the case where the display image is a solid-color display image in its entirety, it is similarly applicable to the case where apart of the display image includes a solid-color display image area. In this case, based on an RGB separation signal outputted by the RGB signal processing portion 31, the image determination portion 32 determines whether a solid-color display image area is included in an image to be displayed with the signal, and if included, a determination is made regarding the position of the solid-color display image area. The lighting pattern selection portion 33 provides the PWM signal output portion 34 with PWM data acquired from the lighting pattern storage portion 30 in accordance with the solid-color display image for which the determination was made, and controls the PWM signal output portion 34 such that only the LEDs that are situated in the determined position (and its vicinity) are lit in a lighting pattern suitable for the solid-color display. As a result, it is possible to reduce or eliminate uneven luminance in the partial solid-color display image area.

Still furthermore, the present embodiment has been described taking as an example the so-called direct backlight in which backlight units including LEDs are disposed directly below the liquid crystal panel 10. While this configuration renders display unevenness of the solid-color display image noticeable, this configuration is not restrictive, and a so-called tandem backlight may be used in which light-guide plates are disposed directly below the liquid crystal panel 10, and light is supplied from ends of the light-guide plates. If the lighting pattern for LEDs included in a plurality of backlight units are adjusted so as to be preferable for displaying a solid-white display image, this configuration also causes uneven luminance (here, differences or variations in luminance) when a solid-blue display image is displayed, and therefore by using two lighting patterns while switching them as in the embodiment, it becomes possible to reduce or eliminate uneven luminance (e.g., differences in luminance). Note that one or more types of LEDs used in this backlight may be combined with other self-luminous devices, phosphors, and the like.

Also, in the present embodiment, LEDs of three primary colors, red, green, and blue, are included, but LEDs of four primary colors, additionally including white or cyan LEDs, or LEDS of five primary colors, red, green, blue, cyan, and yellow, or even more primary colors, may be included so long as white light can be obtained. Also, LEDs of two primary colors, such as blue and yellow, may be included, although natural colors might not be displayed with satisfactory color reproduction.

In addition, in the present embodiment, the backlight 20 is configured using LEDs with superior color reproducibility, but instead of this, the backlight may be configured by two-dimensionally arranging self-luminous devices (such as those for organic EL displays) capable of emitting colors which are similar to those of the LEDs but are different in properties, or may be combined with LEDs for emitting one or more of the aforementioned primary colors.

### INDUSTRIAL APPLICABILITY

The present invention is applicable to liquid crystal display devices having the function of controlling backlight luminance, and is particularly suitable for liquid crystal display devices in which a liquid crystal panel and light sources for two or more colors are provided.

### DESCRIPTION OF THE REFERENCE CHARACTERS

1 liquid crystal display device
2 video signal source
10 liquid crystal panel
11 scanning signal line driver circuit
12 video signal line driver circuit
20 backlight
21 optical sheet group
22 diffuser panel
23 backlight board
24 LED
25 backlight casing
30 lighting pattern storage portion
31 RGB signal processing portion
32 image determination portion
33 lighting pattern selection portion
34 PWM signal output portion
35 drive control portion

1. A liquid crystal display device having a function of controlling backlight luminance, comprising:
a liquid crystal panel for displaying an image based on external video data;
a backlight including a plurality of light sources for each of two or more primary colors, independently controllable for luminance;
an image determination portion for determining whether the image in its entirety or in part is a solid-color display image of at least almost only a single predetermined color;
a storage portion having solid-color display data and normal display data stored therein, the solid-color display data determining the luminance of the light sources and being preset such that the solid-color display image is displayed on the liquid crystal panel without unevenness, the normal display data determining the luminance of the light sources and being preset in order to provide a display image different from the solid-color image; and
a lighting control portion for controlling the light sources based on the solid-color display data stored in the storage portion when the determination by the image determination portion indicates the solid-color display image and based on the normal display data stored in the storage portion when otherwise.

2. The liquid crystal display device according to claim 1, wherein,
when the determination indicates the solid-color display image, the image determination portion makes another determination as to whether the image in its entirety or in part is one of a plurality of solid-color display images that has a different one of the two or more primary colors as the single color,
the storage portion has stored therein a plurality of pieces of solid-color display data corresponding to the solid-color display images, the solid-color display data determining the luminance of the light sources and being preset such that their corresponding solid-color display images are displayed on the liquid crystal panel without unevenness, and
when the determination by the image determination portion indicates the solid-color display image, the lighting control portion controls the light sources based on one piece of the solid-color display data stored in the storage portion that corresponds to the determination result by the image determination portion.

3. The liquid crystal display device according to claim 1, wherein the solid-color display data stored in the storage portion is preset such that a solid-color display image of one color other than white as the single color is provided without unevenness, and the normal display data stored in the storage portion that determines the luminance of the light sources is preset such that a display image of at least almost only white is provided without unevenness.

4. The liquid crystal display device according to claim 1, wherein at least one of the solid-color display images has blue as the single color, the blue being one of the two or more primary colors including red, blue, and green.

5. The liquid crystal display device according to claim 1, wherein the image determination portion makes the determination based on color-by-color average signal levels included in the video signal.

6. The liquid crystal display device according to claim 1, wherein the backlight includes light-emitting diodes as the light sources.

7. The liquid crystal display device according to claim 1, wherein the backlight is of a direct type in which the light sources are disposed along a plane opposite to a display surface of the liquid crystal panel.

8. A method for controlling a liquid crystal display device with a liquid crystal panel for displaying an image based on external video data and a backlight including a plurality of light sources for each of two or more primary colors, independently controllable for luminance, the method comprising:
an image determination step of determining whether the image in its entirety or in part is a solid-color display image of at least almost only a single predetermined color;
a storage step of storing solid-color display data and normal display data, the solid-color display data determining the luminance of the light sources and being preset such that the solid-color display image is displayed on the liquid crystal panel without unevenness, the normal display data determining the luminance of the light sources and being preset in order to provide a display image different from the solid-color image; and
a lighting control step of controlling the light sources based on the solid-color display data stored in the storage step when the determination in the image determination step indicates the solid-color display image and based on the normal display data stored in the storage step when otherwise.
